(19) United States
(12) Patent Application Publication
(10) Pub. No.: US 2001/0032083 A1
(43) Pub. Date: Oct. 18, 2001

(54) Language independent speech architecture

(76) Inventor: Philip Van Cleven, Deinze (BE)

Correspondence Address: BROMBERG & SUNSTEIN LLP, 125 SUMMER STREET, BOSTON, MA, 02110-1618, US

(21) Appl. No.: 09/791,395

(22) Filed: Feb. 22, 2001

Related U.S. Application Data
(60) Provisional application No. 60/184,473, filed on Feb. 23, 2000.

(51) Int. Cl. G10L 11/00; G10L 21/00

(52) U.S. Cl. 704/270.1

(57) ABSTRACT

A service object provides a speech-enabled function over a network. An input to the service object has a first address on the network, and receives a stream of requests in a first defined data format for performing the speech enabled-function. An output from the service object has a second address on the network, and provides a stream of responses in a second defined data format to the stream of requests. The service object also has non-null set of service processes, wherein each service process is in communication with the input and the output, for performing the speech-enabled function in response to a request in the stream.

The present application claims priority from U.S. provisional patent application No. 60/184,473, filed Feb. 23, 2000, and incorporated herein by reference.

### TECHNICAL FIELD

The present invention relates to devices and methods for providing speech-enabled functions to digital devices such as computers.

### BACKGROUND ART

The speech user interface (SUI) is typically achieved by recourse to a script language (and related tools) for writing scripts that, once compiled, will coordinate during run-time a specified set of dialogue functions and allocate specialized speech resources such as automatic speech recognition (ASR) and text to speech (TTS). At the same time, the SUI framework allows the developer to design a complete solution where the speech resources and the more standard components such as databases can be seamlessly integrated.

Today's implementation of the SUI makes it possible for a person to interact with an application in a less structured way compared to more traditional state-driven intelligent voice response (IVR) systems. The use of dynamic BNF grammar descriptors utilized by the SUI allows the system to interact in a more natural way. Today's systems allow in a limited way a “mixed initiative” dialogue: such systems are, at least in some instances, able to recognize specific keywords in a context of a natural spoken sentence.

The SUI of today is rather monolithic and limited in supported platform capabilities and in its flexibility. The SUI typically consumes considerable computer resources. Once the system is compiled, the BNF becomes “hard coded” and therefore the dialogue structure cannot be changed (although the keywords can be extended). The compiled version allocates the language resources as run-time processes. As result, the processor load is high and top line servers are commonly necessary.

Implementing the SUI itself is a complex task, and application developers confronting this task have to have insight not only into the application definition but also into computer languages utilized by the SUI, such C and C.

### SUMMARY OF THE INVENTION

In a first embodiment of the invention there is provided a service object, for providing a speech-enabled function over a network. In this embodiment, the service object has an input and an output at first and second addresses respectively on the network. The input is for receiving a stream of requests in a first defined data format for performing the speech enabled-function. The output is for providing a stream of responses in a second defined data format to the stream of requests. The service object also includes a non-null set of service processes. Each service process is in communication with the input and the output, and performs the speech-enabled function in response to a request in the stream.

In a further related embodiment, the service object also has a run-time manager, coupled to the input. The run-time manager distributes requests from the stream among processes in the set and managing the handling of the requests thus distributed, wherein each service process includes a service user interface, a service engine, and a run-time control.

Another related embodiment includes an arrangement that causes the publication over the network of the availability of the service object.

As an optional feature of these embodiments, the run-time manager has a proxy mode and a command mode, so that a plurality of service objects may be operated in communication with one another, with a common input and a common output, so that the run-time manager of a first service object of the plurality is be operative in the command mode and the run-time manager of each of the other service objects of the plurality is operative in the proxy mode. In this way the run-time manager that is in the command mode manages the remaining run-time managers, which are in the proxy mode.

Also in further embodiments, the speech enabled-function is selected from the group consisting of text-to-speech processing, automatic speech recognition, speech coding, pre-processing of text to render a textual output suitable for subsequent text-to-speech processing, and pre-processing of speech signals to render a speech output suitable for automatic speech recognition.

In yet another further embodiment, the speech enabled-function is text-to-speech processing employing a “large speech database”, as that term is defined below.

In the foregoing embodiments, the object may be in communication over the network with a plurality of distinct types of applications that utilize the object to perform the speech enabled-function. The network may be a global communication network, such as the Internet. Alternatively, the network may be a local area network or a private wide area network.

In further embodiments, the object may be coupled to a telephone network, so that the speech enabled-function is provided to a user of a telephone over the telephone network. The telephone network may be land-based or it may be a wireless network.

### BRIEF DESCRIPTION OF THE DRAWINGS

The foregoing features of the invention will be more readily understood by reference to the following detailed description, taken with reference to the accompanying drawings, in which:

FIG. 1 is a block diagram showing how service objects for providing various speech-enabled functions may be employed in accordance with an embodiment of the present invention.

FIG. 2 is a block diagram of the service object 13 of FIG. 1 for providing text-to-speech processing in accordance with an embodiment of the present invention.

FIG. 3 is a block diagram of a set of service objects for performing a speech-enabled function, similar to the service objects of FIG. 1, showing how a single run-time manager in one of the service objects can manage the other run-time managers, which serve as proxy run-time managers.

### DETAILED DESCRIPTION OF SPECIFIC EMBODIMENTS

Definitions. As used in this description and the accompanying claims, the following terms shall have the meanings indicated, unless the context otherwise requires:

A “speech-enabled function” is a function that relates to the use or processing of speech or language in a digital environment, and includes functions such as text-to-speech processing (TTS), automatic speech recognition (ASR), machine translation, speech data format conversion, speech coding and decoding, pre-processing of text to render a textual output suitable for subsequent text-to-speech processing, and pre-processing of speech signals to render a speech output suitable for automatic speech recognition.

“Large speech database” refers to a speech database that references speech waveforms. The database may directly contain digitally sampled waveforms, or it may include pointers to such waveforms, or it may include pointers to parameter sets that govern the actions of a waveform synthesizer. The database is considered “large” when, in the course of waveform reference for the purpose of speech synthesis, the database commonly references many waveform candidates, occurring under varying linguistic conditions. In this manner, most of the time in speech synthesis, the database will likely offer many waveform candidates from which a single waveform is selected. The availability of many such waveform candidates can permit prosodic and other linguistic variation in the speech output, as described in further detail in patent application Ser. No. 09/438,603, filed Nov. 12, 1999, entitled “Digitally Sampled Speech Segment Models Employing Prosody.” Such related application is hereby incorporated herein by reference.

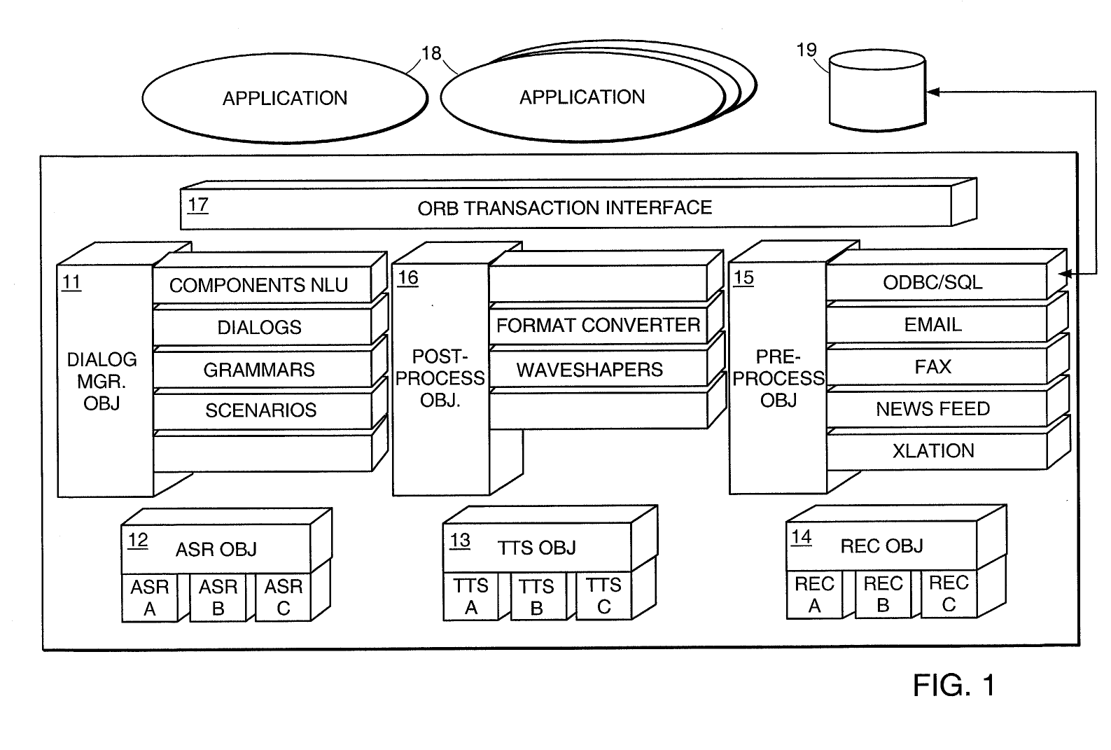

FIG. 1 is a block diagram showing how service objects for providing various speech-enabled functions may be employed in accordance with an embodiment of the present invention. This embodiment may be implemented so as to provide both a framework for the software developer as well as a series of speech-enabled services at run time.

At development time, the framework allows the developer to define the interaction between a user and an application 18 illustrated in FIG. 1. The interaction is typically in the form of a scenario or dialogue between the two objects, human and application. In order to establish the interaction, the present embodiment provides a series of special language resources which are pre-defined as service objects. Each object is able to fulfill a particular action in the dialogue. Hence there are illustrated in FIG. 1 an ASR object 12 for performing ASR, a TTS object 13 for performing TTS, a record object 14 for performing record functions, a preprocessor object 15 for handling text processing for various speech and language functions, and postprocessor object 16 for handling speech formatting and related functions. In addition, a dialogue object 11 is provided to define the scenario wherein a resource is used.

Scenarios defined by the dialogue object 11 may include the chaining of resources. Each of the scenarios can therefore include several sub-scenarios that can be executed in parallel or sequentially. Typically, parallel executed scenarios may be used to describe a “barge-in” functionality where one branch may be executing a TTS function, for example, and the other branch may be running an ASR function.

It is the dialogue object 11 that is responsible for the management of the scenarios. The dialogue object 11 interprets the results from the various service objects and activates or deactivate alternative scenarios. The interpretation of the received data will be determined by the intelligence of dialogue object. Hence in various embodiments, “natural language understanding” is built into the dialogue object 11. During run-time, the dialogue object uses BNF definitions to capture defined data classes. The dialogue object 11 therefore includes modules for request management, natural language understanding (NLU), and run-time scenario management.

The ASR object 12 is implemented to contain containing the run-time management modules for a series of ASR engines providing various types of ASR capability, namely small-vocabulary and large-vocabulary speaker-dependent recognition engines and small-vocabulary and medium vocabulary speaker-independent recognition engines.

The TTS object 13 contains a run-time management module and various TTS engines, including a compact engine and a more realistic but more computationally demanding engine. Depending on the member in the TTS engine family, some of the members are context-aware: they have knowledge to interpret text to enhance the “readability” of a text depending on context (for example, Email context, fax context, newsfeed, optical character recognition output, etc.) However, to the extent that such knowledge is not present, the preprocessor object 15 may be employed to provide a text output that has been processed from a text input to improve readability of the text after taking into account the context of from which the text input has arisen.

The recorder object 14 contains a run-time management module and the different components of the recorder family, including not only voice encoding but also encryption of voice and data, and with event logging capabilities. Companders and codex systems are part of this object.

The postprocessors object 16 contains modules for processing digitized speech audio.

Each object includes a set of service engines to perform the speech-related function of the object and a management module responsible for the run-time behavior of the service engines. The run-time management module is the central place of the object where external requests are received and where an address and busy/free table are maintained for all the service engines of the object. Each object can therefore be seen as a media service offered to applications. The media service may be offered, for example, as an independent Windows NT service or a UNIX daemon.

As previously described, each object is capable of hosting multiple different service engine types. Each service engine may advertise its capabilities to the run-time manager of the object during a definition and initialization phase. During run time, the run-time manager selects which service engine it wants to allocate for a particular transaction.

The service objects may be run on a single computer (where multiple threads or processes are used to support multiple members) or may be distributed over a multiple heterogeneous computers. The framework of this embodiment allows each of the service objects to “plug in” into the framework at the definition time and at run-time. While each service object is part of the overall framework, it may also be addressed independently. To allow a full accessibility of a service in a server farm by external applications, each object may be advertised as a CORBA (or other ORB) based service and therefore the service can be reached via (C)ORB(A) messages. (C)ORB(A) will resolve the location and the address of the wanted service. The output of a service is again a (C)ORB(A)-based message.

All fields in the (C)ORB(A) messages employ a defined structure that is ASN1-based. Internal communication within an object also employ a defined messages that have a structure that is based on ASN1. As it consists of a private implementation, there is no need to allow variable structures or positioning of message elements but the version per message element is a necessary part. This will allow mixing of old and new versions of members in a subsystem.

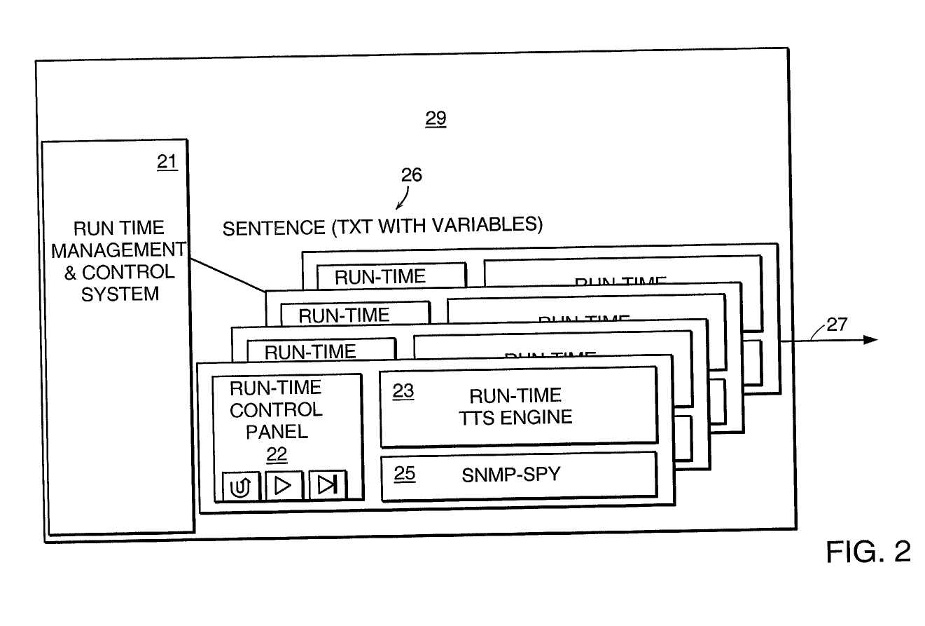

FIG. 2 is a block diagram of the service object 13 of FIG. 1 for providing text-to-speech processing in accordance with an embodiment of the present invention. The service object is realized as a text-to-speech object 29, in which a set of run-time TTS engines 23 is employed to process a text input 26 and provide a speech output 27. With each engine 23 is associated a run-time control panel 22 and associated run-time control, as well as a network interface 25, such as an SNMP spy.

The TTS engines 23 are managed by run-time management and control system 21. This module controls the number of concurrent instances there will be available on any given time and is responsible for instantiating and initializing the different instances. The module is thus responsible for load sharing and load balancing. It may employ methods that will send the “texts” to the first available run-time instance or that will send the “texts” to the run-time instances on a round-robin basis. The module is also responsible for the management of sockets, including the allocation and destruction of temporary run-time sockets and static allocated sockets. The management module can be located on a different machine from the other modules. The number of instances it can manage of the run-time system should be determined by the power of the machine and the memory model used.

Each service process includes the appropriated graphic user interface (GUI), TTS engine, and SNMP spy.

GUI

The GUI is a window (windows or X windows) in where the different attributes of its TTS can be modified and tuned. The attributes depend on the underlying TTS and control the voice attributes such as speed, pitch and others.

The GUI can be set into 2 states:

run-time: normal operations, all options are greyed and the underlying TTS uses the attribute settings as they were set

programming: the system administrator or the person with the correct security level can modify the different settings.

The GUI comes with default settings. The default setting will be discussed during the following meetings.

The TTS engine

Each TTS engine comes as a fully configured system with its appropriate resources. Each engine instance has full knowledge on its own load and will never go into overload where the real-time behavior of the system is not guaranteed. Each engine generates audio signals and places them on the socket that was assigned for that transaction. The format of the audio signals is defined by the attributes set by its associated GUI.

Each TTS service process is “blocking”: it is waiting for requests (transactions) on its message interface. When no transactions are active, the TTS process will sleep and therefore not inflect any processor load.

The input of the service process is seen as a pipe in which messages can be posted. Each message results in a transaction of Text to Speech. It is possible to have multiple messages in the pipe while the instance is handling a transaction. As long as the “real-time behavior is not affected, the number of waiting messages is not limited.

SNMP Spy

The SNMP (Small Network Management Protocol) module acts as a local agent that is able to collect run-time errors. It can be interrogated by a management system (such as HP Open View or the Microsoft SMC application) or it can send the information unsolicited to those applications (if they are known to the SNMP agent).

The agent will be able to receive instructions from the management tool to

Instantiate

Initialize

Start

Re-initialize

Stop

the appropriate components of the process.

Input and Output of the service object are as follows:

| Input/ | | |
|---|---|---|
| Output | Name | Description |
| Input | Text_Index(index, | Message type send into a socket (blocked |
| | Type, P1...Pn) | read) Index is the index in the database |
| | | Type : run type indication for the engines |
| | | such as male/female/etc. |
| | | P1... Pn are parts of a text that will be |
| | | slotted in into a framed text |
| Input | Stop (P1) | Stop of the transaction |
| | | P1 : indication how to stop (immediately, |
| | | after the word, at the end of the sentence |
| Output | Buffer | Output indication over a socket, buffer |
| | | transfer could be over a socket or using |
| | | shared memory (using the socket for flow |
| | | control) Buffers containing the audio. |
| output | Socket-id | To the process or the client who requested |
| | | the transaction |
| | | Socket identity on which the buffers will |
| | | be available |
| output | Error message | To the process or client who requested the |
| | | transaction |
| | | Error type and reason |
| Output | SNMP messages | To the external SMC or similar application |
| | | (HP open view oriented) |

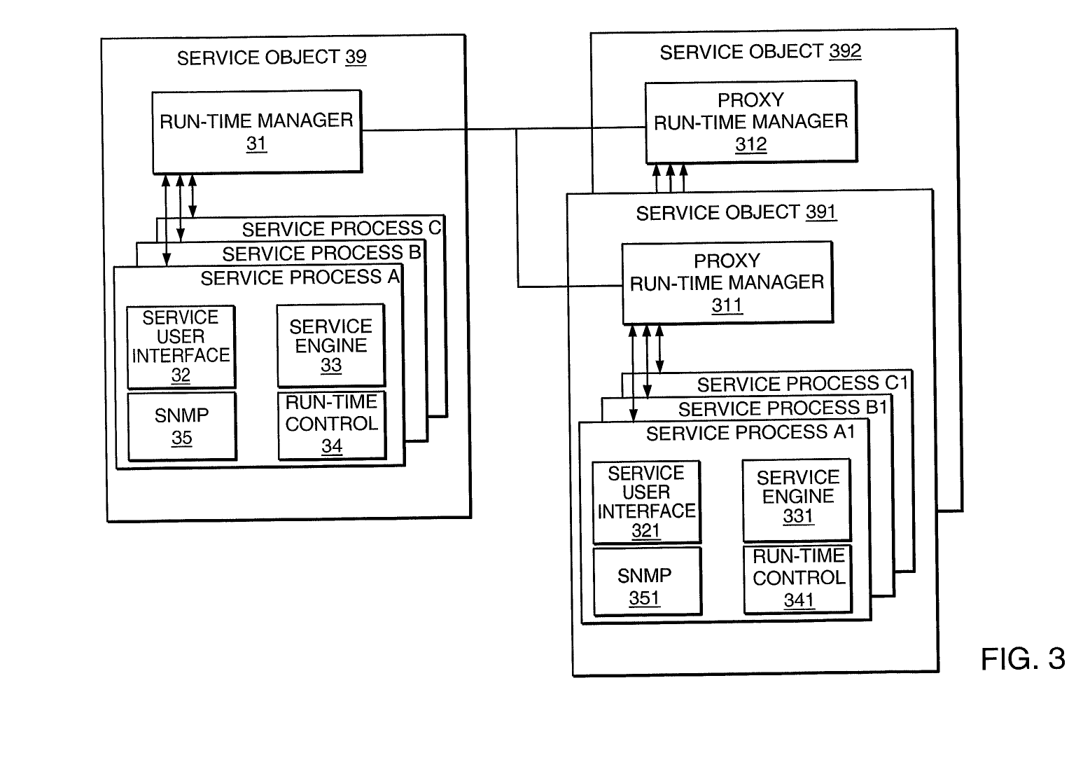

FIG. 3 is a block diagram of a set of service objects for performing a speech-enabled function, similar to the service objects of FIG. 1, showing how a single run-time manager in one of the service objects can manage the other run-time managers, which serve as proxy run-time managers. Here in a manner analogous to FIG. 2, a service object 39 includes a run-time manager 31, which manages a set of service processes, shown here as processes A, B, and C. Each process includes a service engine 33, a run-time control 34, a service user interface 32, and a network interface 35. In this case service object 39 is one of a set of service objects that also includes service objects 391 and 392 having run-time managers 311 and 312 respectively. The run-time manager 31 of service object 39 also provides overall control of run-time managers 311 and 312, which are configured as proxies of run-time manager 31. Thus a run-time manager can be configured either as local manager serving as a proxy for another run-time manager or as a manager handling control not only of processes directly associated with the service object but also of process associated with proxy service objects.

What is claimed is:

1. A service object, for providing a speech-enabled function over a network, the service object comprising:
a. an input, having a first address on the network, for receiving a stream of requests in a first defined data format for performing the speech enabled-function;
b. an output, having a second address on the network, for providing a stream of responses in a second defined data format to the stream of requests;
c. a non-null set of service processes, each service process in communication with the input and the output, for performing the speech-enabled function in response to a request in the stream.

2. An object according to claim 1, further comprising:
d. a run-time manager, coupled to the input, for distributing requests from the stream among processes in the set and for managing the handling of the requests thus distributed.

3. An object according to claim 1, wherein each service process includes a service user interface, a service engine, and a run-time control.

4. An object according to claim 1, further comprising an arrangement that causes the publication over the network of the availability of the service object.

5. An object according to claim 1, wherein the run-time manager has a proxy mode and a command mode, so that a plurality of service objects may be operated in communication with one another, with a common input and a common output, so that the run-time manager of a first service object of the plurality is be operative in the command mode and the run-time manager of each of the other service objects of the plurality is operative in the proxy mode.

6. An object according to any of claims 1-5, wherein the speech enabled-function is selected from the group consisting of text-to-speech processing, automatic speech recognition, speech coding, pre-processing of text to render a textual output suitable for subsequent text-to-speech processing, and pre-processing of speech signals to render a speech output suitable for automatic speech recognition.

7. An object according to claim 6, wherein the speech enabled-function is text-to-speech processing employing a large speech database.

8. An object according to any of claims 1-5, wherein the object is in communication over the network with a plurality of distinct types of applications that utilize the object to perform the speech enabled-function.

9. An object according to any of claims 1-5, wherein the network is the a global communication network.

10. An object according to claim 9, wherein the network is the Internet.

11. An object according to any of claims 1-5, wherein the network is a local area network.

12. An object according to any of claims 1-5, wherein the network is a private wide area network.

13. An object according to any of claims 1-5, wherein the object is coupled to a telephone network, so that the speech enabled-function is provided to a user of a telephone over the telephone network.

14. An object according to claim 13, wherein the telephone network is a wireless network.
